(19) United States
(12) Patent Application Publication
(10) Pub. No.: US 2024/0267138 A1
(43) Pub. Date: Aug. 8, 2024

(54) TRANSCEIVER AND LOOPBACK TEST METHOD FOR TRANSCEIVER

(71) Applicant: Samsung Electronics Co., Ltd., Suwon-si (KR)

(72) Inventors: Yungeun NAM, Suwon-si (KR); Hobin SONG, Suwon-si (KR); Hyogyuem RHEW, Suwon-si (KR); Jaehyun PARK, Suwon-si (KR); Jongshin SHIN, Suwon-si (KR)

(73) Assignee: Samsung Electronics Co., Ltd., Suwon-si (KR)

(21) Appl. No.: 18/431,087

(22) Filed: Feb. 2, 2024

(30) Foreign Application Priority Data
Feb. 3, 2023 (KR) 10-2023-0014905
Apr. 5, 2023 (KR) 10-2023-0044790

(51) Int. Cl. H04B 17/29; H04B 17/19

(52) U.S. Cl. CPC H04B 17/297; H04B 17/19; H04B 17/295

(57) ABSTRACT

A transceiver according to an aspect of the inventive concepts may include a transmitter, a first receiver pad configured to receive a first external voltage, a second receiver pad configured to receive a second external voltage, a receiver configured to generate a test target signal based on the first external voltage and the second external voltage, and a digital logic configured to perform a loopback test on a reception path of a data signal by transmitting the data signal and receiving the test target signal.

### CROSS-REFERENCE TO RELATED APPLICATION

This application is based on and claims priority under 35 U.S.C. §119 to Korean Patent Application Nos. 10-2023-0014905, filed on Feb. 3, 2023, and 10-2023-0044790, filed on Apr. 5, 2023, in the Korean Intellectual Property Office, the disclosures of which are incorporated by reference herein in their entireties.

### BACKGROUND

The inventive concepts relate to a transceiver, and more particularly, to a loopback test method for a transceiver.

Methods of testing a transceiver may include an internal loopback test method, an external loopback test method, and a full path internal loopback test method.

In the internal loopback test method, external loopback test method, and full pass internal loopback test method, situations such as low test coverage, poor testing at high frequencies, or inclusion of an additional test circuit that occupies a large area, may occur.

### SUMMARY

Embodiments may provide for a method that has higher test coverage, allows smoother testing even at higher frequencies, and may perform loopback testing without a test circuit.

The inventive concepts provide a loopback test method for a transceiver.

The inventive concepts are not limited to those mentioned above. Also, the inventive concepts may be clearly understood by those skilled in the art from the description below.

According to an aspect of the inventive concepts, there is provided a transceiver including a transmitter, a first receiver pad configured to receive a first external voltage, a second receiver pad configured to receive a second external voltage, a receiver configured to generate a test target signal based on the first external voltage and the second external voltage, and a digital logic configured to perform a loopback test on a reception path of a data signal by transmitting the data signal and receiving the test target signal.

According to an aspect of the inventive concepts, there is provided a transceiver including a first receiver pad configured to receive a first external voltage, a second receiver pad configured to receive a second external voltage, a first multiplexer (MUX) connected to the first receiver pad and the second receiver pad, a second MUX connected to the first receiver pad and the second receiver pad, a receiver analog front end (RX AFE), the first MUX and the second MUX each being connected to an input terminal of the RX AFE, a clock data recovery (CDR) de-serializer connected to the RX AFE, a digital logic connected to the CDR de-serializer, the digital logic being configured to perform a loopback test on a reception path of a data signal by generating the data signal, and a serializer connected to the first MUX, the second MUX, and the digital logic.

According to an aspect of the inventive concepts, there is provided a loopback test method for a transceiver, the method including transmitting a data signal to a serializer, transmitting a serializer output signal from the serializer to a first multiplexer (MUX) and a second MUX, transmitting a first MUX output signal and a second MUX output signal to a receiver analog front end (RX AFE) based on a first external voltage input to a first receiver pad, a second external voltage input to a second receiver pad, and the serializer output signal, the transmitting including transmitting the first MUX output signal from the first MUX and transmitting the second MUX output signal from the second MUX, transmitting an RX AFE output signal from the RX AFE to a clock data recovery (CDR) de-serializer, transmitting a test target signal from the CDR de-serializer to a digital logic, and determining that a loopback test is passed when the data signal and the test target signal are the same.

### BRIEF DESCRIPTION OF THE DRAWINGS

Embodiments of the inventive concepts will be more clearly understood from the following detailed description taken in conjunction with the accompanying drawings in which:

FIG. 1 is a block diagram showing a transceiver according to embodiments;

FIG. 2 is a block diagram showing a more detailed illustration of the transceiver of FIG. 1 according to embodiments;

FIG. 3 is a block diagram showing a transceiver including a terminating resistor circuit according to embodiments;

FIG. 4 is a block diagram showing a transceiver in a positive data transition mode according to embodiments;

FIG. 5 is a block diagram showing a transceiver in a negative data transition mode according to embodiments;

FIG. 6 is a flowchart for explaining a loopback test method according to embodiments;

FIG. 7 is a flowchart for explaining the operation of a digital logic according to embodiments;

FIG. 8 is a flowchart for explaining the operation of a serializer according to embodiments;

FIG. 9 is a flowchart for explaining an operation of a first multiplexer (MUX) according to embodiments;

FIG. 10 is a flowchart for explaining the operation of a second MUX according to embodiments;

FIG. 11 is a flowchart for explaining the operation of a receiver analog front end (RX AFE) according to embodiments; and

FIG. 12 is a flowchart for explaining the operation of a clock data recovery (CDR) de-serializer according to embodiments.

### DETAILED DESCRIPTION

Hereinafter, embodiments of the inventive concepts will be described in detail with reference to the attached drawings.

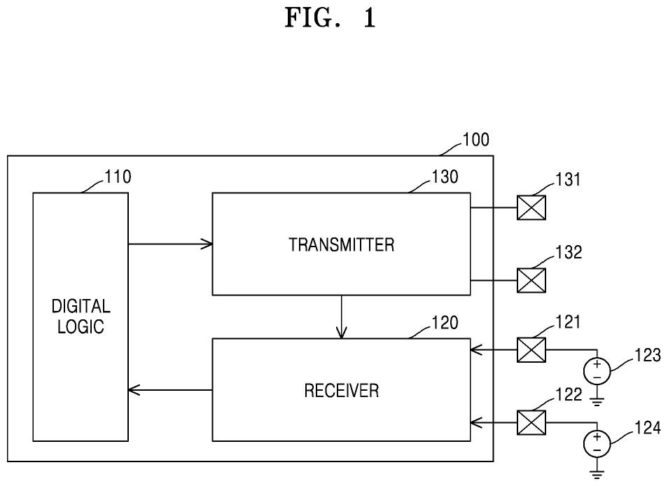

FIG. 1 is a block diagram showing a transceiver according to embodiments.

A transceiver 100 according to embodiments may include a digital logic 110, a receiver 120, a transmitter 130, a first transmitter pad 131, a second transmitter pad 132, a first receiver pad 121, and/or a second receiver pad 122.

The digital logic 110 may be configured to generate data signals. The digital logic 110 may perform a loopback test on the transceiver 100 by generating a data signal and transmitting the generated data signal to the transmitter 130. In detail, the data signal transmitted from the digital logic 110 may be transmitted to the receiver 120 through some components of the transmitter 130. According to embodiments, the data signal may be a random (or pseudorandom) data signal. In addition, the signal transmitted to the receiver 120 may be transmitted back to the digital logic 110 through components of the receiver 120. When the data signal generated by digital logic 110 is transmitted back to the digital logic 110 through a portion of the transmitter 130 and the receiver 120, the signal transmitted to digital logic 110 may be referred to as a test target signal.

The digital logic 110 may derive test results for a transceiver loopback test based on the generated data signal and the received test target signal. In detail, even if the data signal generated by the digital logic 110 passes through the transmitter 130 and the receiver 120, the data signal may be received by the digital logic 110 as the same signal (or a similar signal). This case may be referred to as the loopback test was passed (e.g., successfully passing the loopback test). Conversely, the data signal generated by the digital logic 110 may change as the generated data signal passes through the transmitter 130 and the receiver 120. Therefore, the data signal and the test target signal may not be the same (or may not be similar). This case may be referred to as the loopback test was failed (e.g., failing the loopback test).

The digital logic 110 may compare the data signal with the test target signal to determine the result of the loopback test. In other words, the digital logic 110 may determine whether the data signal and the test target signal are the same (or similar). According to embodiments, for example, the digital logic 110 may determine whether the data signal and the test target signal match. The digital logic 110 may determine that the loopback test has passed when the data signal and the test target signal are the same (or similar) and may determine that the loopback test has failed when the data signal and the test target signal are different from each other.

The receiver 120 may be connected to the digital logic 110. In addition, the receiver 120 may be connected to the transmitter 130.

The receiver 120 may be connected to the first receiver pad 121 and the second receiver pad 122. The first receiver pad 121 may be configured to be applied a first external voltage 123. In addition, the second receiver pad 122 may be configured to be applied a second external voltage 124. By receiving the first external voltage 123 and/or the second external voltage 124 from the first receiver pad 121 and/or the second receiver pad 122, the transceiver 100 may perform a loopback test on the entire reception path of the receiver 120 without a separate test circuit.

The receiver 120 may be configured to generate the test target signal based on the first external voltage 123 and the second external voltage 124. More specific details regarding the receiver 120 are described below.

The transmitter 130 may be connected to the digital logic 110. In addition, the transmitter 130 may be connected to the receiver 120.

The transmitter 130 may be connected to the first transmitter pad 131 and the second transmitter pad 132. A voltage may be applied to the first transmitter pad 131 and/or the second transmitter pad 132 by the transmitter 130. In other words, a voltage corresponding to the transmission signal of the transmitter 130 may be applied to the first transmitter pad 131 and/or the second transmitter pad 132.

The first external voltage 123 may be a voltage corresponding to logical high. In addition, the second external voltage 124 may be a voltage corresponding to logical low. For example, the first external voltage 123 may be about 300 mV and the second external voltage 124 may be about 100 mV. However, this is only an example for convenience of explanation, and embodiments of the inventive concepts are not limited thereto. According to embodiments, each of the first external voltage 123 and the second external voltage 124 may be variable. For example, each of the first external voltage 123 and the second external voltage 124 may be adjusted using, for instance, equipment external to the transceiver 100.

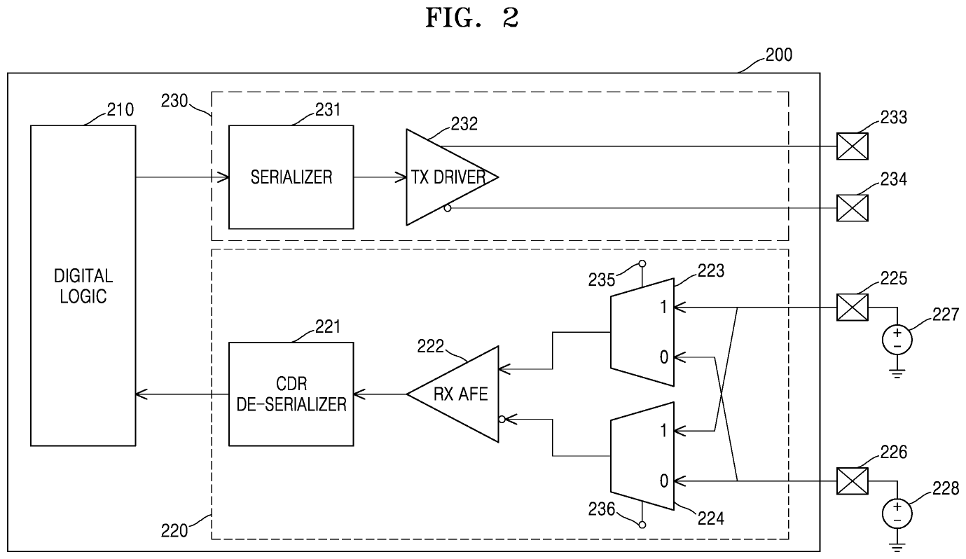

FIG. 2 is a block diagram showing a more detailed illustration of the transceiver of FIG. 1 according to embodiments.

A transceiver 200 according to embodiments may include a digital logic 210, a receiver 220, a transmitter 230, a first transmitter pad 233, a second transmitter pad 234, a first receiver pad 225 to which a first external voltage 227 is applied, and/or a second receiver pad 226 to which a second external voltage 228 is applied. The transceiver 200, the digital logic 210, the receiver 220, the transmitter 230, the first transmitter pad 233, the second transmitter pad 234, the first receiver pad 225 to which the first external voltage 227 is applied, and second receiver pad 226 to which the second external voltage 228 is applied may correspond to the transceiver 100, the digital logic 110, the receiver 120, the transmitter 130, the first transmitter pad 131, the second transmitter pad 132, the first receiver pad 121 to which the first external voltage 123 is applied, and the second receiver pad 122 to which the second external voltage 124 is applied of FIG. 1, respectively.

The receiver 220 may include a clock data recovery (CDR) de-serializer 221, a receiver analog front end (RX AFE) 222, a first multiplexer (MUX) 223, and/or a second MUX 224.

The first MUX 223 may be connected to the first receiver pad 225 to which the first external voltage 227 is applied. In addition, the first MUX 223 may be connected to the second receiver pad 226 to which the second external voltage 228 is applied. In addition, although not shown in the drawing, the first MUX 223 may be connected to a serializer 231 through a terminal 235.

The first MUX 223 may be configured to generate a first MUX signal based on the output signal of the serializer 231. The output signal of the serializer 231 may be referred to as a serializer output signal or a serializer signal. The output signal of the first MUX 223 may be referred to as a first MUX signal or a first MUX output signal. The first MUX signal may be transmitted from the first MUX 223 to the RX AFE 222. More specific details for generating the first MUX signal are described below.

The second MUX 224 may be connected to the first receiver pad 225 to which the first external voltage 227 is applied. Additionally, the second MUX 224 may be connected to the second receiver pad 226 to which the second external voltage 228 is applied. In addition, although not shown in the drawing, the second MUX 224 may be connected to the serializer 231 through a terminal 236.

The second MUX 224 may be configured to generate a second MUX signal based on the output signal of the serializer 231. In detail, the second MUX 224 may be configured to receive an inverted serializer signal from the serializer 231 and generate a second MUX signal based on the inverted serializer signal. The output signal of the second MUX 224 may be referred to as a second MUX signal or a second MUX output signal. The second MUX signal may be transmitted from the second MUX 224 to the RX AFE 222. More specific details for generating the second MUX signal are described below.

The RX AFE 222 may be configured to generate an RX AFE signal based on the first MUX signal and the second MUX signal. The output signal of the RX AFE 222 may be referred to as an RX AFE signal or RX AFE output signal. According to embodiments, a voltage difference between the first external voltage 227 and the second external voltage 228 may be greater than or equal to a threshold determined by the RX AFE 222.

The RX AFE 222 may be configured to improve signal characteristics of the signal input to the RX AFE 222. In detail, the RX AFE 222 may be configured to generate an RX AFE signal by compensating for signal distortion or signal loss of the signal input to the RX AFE 222. Accordingly, the RX AFE 222 may be configured to generate an RX AFE signal by compensating for signal distortion or signal loss of the first MUX signal and the second MUX signal.

The CDR de-serializer 221 may be configured to generate a test target signal based on the RX AFE signal. In detail, the CDR de-serializer 221 may be configured to generate the test target signal by reducing the speed of the signal input to the CDR de-serializer 221. Accordingly, the CDR de-serializer 221 may be configured to generate the test target signal by reducing the signal rate of the RX AFE signal. For example, the CDR de-serializer 221 may receive an RX AFE signal in a serial format, and convert the RX AFE signal to generate a test target signal in a parallel format.

The CDR de-serializer 221 may be configured to convert analog signals into digital signals.

The transmitter 230 may include the serializer 231 and/or a transmitter (TX) driver 232.

The serializer 231 may be connected to the digital logic 310. In addition, the serializer 231 may be connected to the TX driver 232. In addition, although not shown in the drawing, the serializer 231 may be connected to the first MUX 223 through the terminal 235. In addition, although not shown in the drawing, the serializer 231 may be connected to the second MUX 224 through the terminal 236.

The serializer 231 may be configured to generate a serializer signal based on the data signal received from the digital logic 210. The output signal of the serializer 231 may be referred to as a serializer signal or a serializer output signal.

The serializer 231 may be configured to generate a serializer signal by increasing the signal rate of the signal input to the serializer 231. Accordingly, the serializer 231 may be configured to generate a serializer signal by increasing the signal rate of the data signal. For example, the serial riser 231 may receive a data signal in a parallel format, and may output a serial riser signal in a serial format by converting the data signal.

The TX driver 232 may be connected to the serializer 231. In addition, the TX driver 232 may be connected to the first transmitter pad 233 and the second transmitter pad 234. The TX driver 232 may generate a TX driver signal and an inverted TX driver signal based on the input signal of the TX driver 232. The output signal of the TX driver 232 may be referred to as a TX driver signal or a TX driver output signal. Assuming that the TX driver signal is a logical high signal, the inverted TX driver signal may be a logical low signal. Conversely, assuming that the TX driver signal is a logical low signal, the inverted TX driver signal may be a logical high signal.

The TX driver signal and the inverted TX driver signal output from the TX driver 232 may be input to the first transmitter pad 233 and the second transmitter pad 234, respectively.

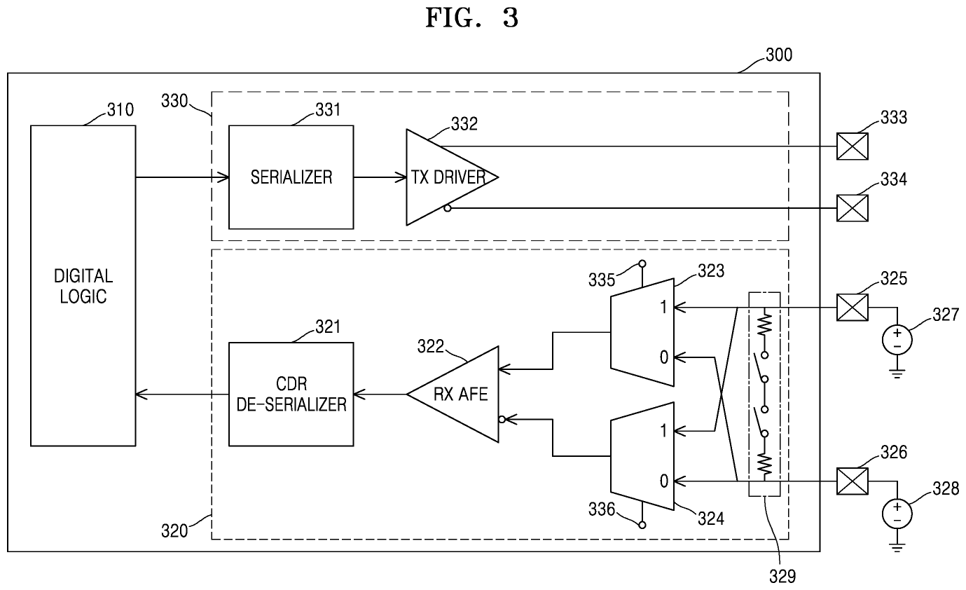

FIG. 3 is a block diagram showing a transceiver including a terminating resistor circuit according to embodiments.

A transceiver 300 according to embodiments may include a digital logic 310, a receiver 320, a transmitter 330, a first transmitter pad 333, a second transmitter pad 334, a first receiver pad 325 to which a first external voltage 327 is applied, and/or a second receiver pad 326 to which a second external voltage 328 is applied. The transceiver 300, the digital logic 310, the receiver 320, the transmitter 330, the first transmitter pad 333, the second transmitter pad 334, the first receiver pad 325 to which the first external voltage 327 is applied, and the second receiver pad 326 to which the second external voltage 328 is applied may correspond to the transceiver 200, the digital logic 210, the receiver 220, the transmitter 230, the first transmitter pad 233, the second transmitter pad 234, the first receiver pad 225 to which the first external voltage 227 is applied, and the second receiver pad 226 to which the second external voltage 228 is applied of FIG. 2, respectively.

The receiver 320 may include a CDR de-serializer 321, an RX AFE 322, a first MUX 323 including a terminal 335, and/or a second MUX 324 including a terminal 336. The CDR de-serializer 321, the RX AFE 322, the first MUX 323 including the terminal 335, and the second MUX 324 including the terminal 336 may correspond to the CDR de-serializer 221, the RX AFE 222, the first MUX 223 including the terminal 235, and the second MUX 224 including the terminal 236 of FIG. 2, respectively.

The receiver 320 may include a terminating resistor circuit 329. The terminating resistor circuit 329 may include at least one terminating resistor and at least one switch capable of changing a terminating resistance value. According to embodiments, for example, the terminating resistance value may change based on whether the at least one switch is on or off (e.g., electrically connecting the at least one terminating resistor to the receiver 320 or electrically disconnecting the at least one terminating resistor from the receiver 320). The terminating resistor circuit 329 shown in FIG. 3 is only an example for convenience of explanation, and embodiments are not limited thereto.

The transmitter 330 may include a serializer 331 and/or a TX driver 332. The serializer 331 and the TX driver 332 may correspond to the serializer 231 and the TX driver 232 of FIG. 2, respectively.

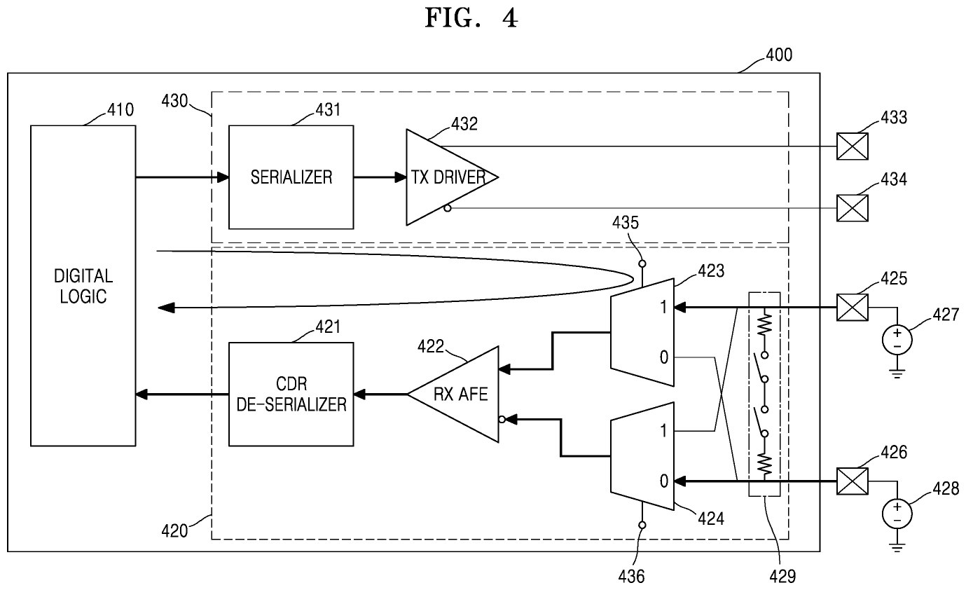

FIG. 4 is a block diagram showing a transceiver in a positive data transition mode according to embodiments.

A transceiver 400 according to embodiments may operate in positive data transition mode or negative data transition mode.

FIG. 4 is a diagram for explaining, in detail, the operation of the transceiver 400 in positive data transition mode.

The transceiver 400 according to embodiments may include a digital logic 410, a receiver 420, a transmitter 430, a first transmitter pad 433, a second transmitter pad 434, a first receiver pad 425 to which a first external voltage 427 is applied, and/or a second receiver pad 426 to which a second external voltage 428 is applied. The transceiver 400, the digital logic 410, the receiver 420, the transmitter 430, the first transmitter pad 433, the second transmitter pad 434, the first receiver pad 425 to which the first external voltage 427 is applied, and second receiver pad 426 to which the second external voltage 428 is applied may correspond to the transceiver 300, the digital logic 310, the receiver 320, the transmitter 330, the first transmitter pad 333, the second transmitter pad 334, the first receiver pad 325 to which the first external voltage 327 is applied, and the second receiver pad 326 to which the second external voltage 328 is applied of FIG. 3, respectively.

The receiver 420 may include a CDR de-serializer 421, an RX AFE 422, a first MUX 423 including a terminal 435, a second MUX 424 including a terminal 436, and/or a terminating resistor circuit 429. The CDR de-serializer 421, the RX AFE 422, the first MUX 423 including the terminal 435, the second MUX 424 including the terminal 436, and the terminating resistor circuit 429 may correspond to the CDR de-serializer 321, the RX AFE 322, the first MUX 323 including the terminal 335, the second MUX 324 including the terminal 336, and the terminating resistor circuit 329 of FIG. 3, respectively.

The transmitter 430 may include a serializer 431 and/or a TX driver 432. The serializer 431 and the TX driver 432 may correspond to the serializer 331 and the TX driver 332 of FIG. 3, respectively.

The positive data transition mode operates when the serializer signal is a signal corresponding to logical high.

For example, the serializer 431 may receive a data signal from the digital logic 410 and generate a serializer signal corresponding to logical high. The first MUX 423 may be configured to generate a first MUX signal corresponding to logical high by the first external voltage 427 by receiving a serializer signal corresponding to logical high through the terminal 435 connected to the serializer 431. According to embodiments, the logical high serializer signal input to the first MUX 423 may cause the first MUX 423 to switch the output of the first MUX 423 to the first external voltage 427 input to the first MUX 423. According to embodiments, the first external voltage 427 may be a voltage corresponding to a logical high.

In addition, the second MUX 424 may be configured to generate a second MUX signal corresponding to logical low by the second external voltage 428 by receiving an inverted serializer signal corresponding to logical low through the terminal 436 connected to the serializer 431. According to embodiments, the inverted serializer signal (logical low) input to the second MUX 424 may cause the second MUX 424 to switch the output of the second MUX 424 to the second external voltage 428 input to the second MUX 424. According to embodiments, the second external voltage 428 may be a voltage corresponding to a logical low.

The RX AFE 422 may be configured to generate an RX AFE signal based on the first MUX signal corresponding to logical high and the second MUX signal corresponding to logical low. In this case, the first MUX signal, the second MUX signal, and the RX AFE signal may be analog signals.

The CDR de-serializer 421 may be configured to generate a test target signal based on the RX AFE signal corresponding to logical high (this is a signal when the RX AFE 422 operates normally). In detail, the CDR de-serializer 421 may be configured to generate the test target signal by reducing the signal rate of the RX AFE signal. The test target signal may be a digital signal. In detail, the test target signal may be a digital signal corresponding to logical high (this is a signal when the CDR de-serializer 421 operates normally).

The digital logic 410 may determine whether to pass/fail the loopback test for the entire receiver path by comparing the transmitted data signal and the received test target signal. According to embodiments, the digital logic 410 may include a memory (e.g., a buffer) that stores the transmitted data signal for later comparison to the received test target signal.

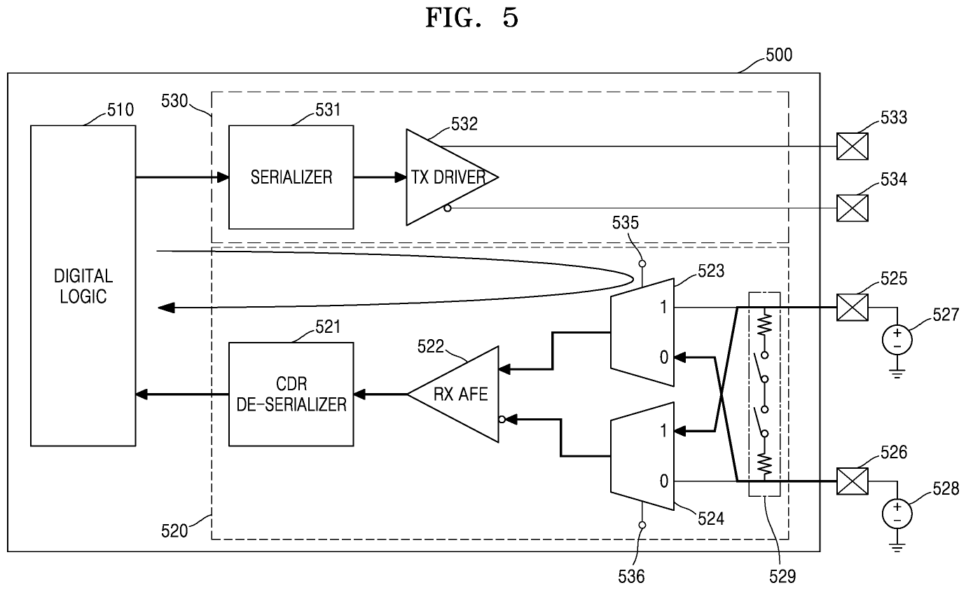

FIG. 5 is a block diagram showing a transceiver in a negative data transition mode according to embodiments.

A transceiver 500 according to embodiments may include a digital logic 510, a receiver 520, a transmitter 530, a first transmitter pad 533, a second transmitter pad 534, a first receiver pad 525 to which a first external voltage 527 is applied, and/or a second receiver pad 526 to which a second external voltage 528 is applied. The transceiver 500, the digital logic 510, the receiver 520, the transmitter 530, the first transmitter pad 533, the second transmitter pad 534, the first receiver pad 525 to which the first external voltage 527 is applied, and the second receiver pad 526 to which the second external voltage 528 is applied may correspond to the transceiver 300, the digital logic 310, the receiver 320, the transmitter 330, the first transmitter pad 333, the second transmitter pad 334, the first receiver pad 325 to which the first external voltage 327 is applied, and the second receiver pad 326 to which the second external voltage 328 is applied of FIG. 3, respectively.

The receiver 520 may include a CDR de-serializer 521, an RX AFE 522, a first MUX 523 including a terminal 535, a second MUX 524 including a terminal 536, and/or a terminating resistor circuit 529. The CDR de-serializer 521, the RX AFE 522, the first MUX 523 including the terminal 535, the second MUX 524 including the terminal 536, and the terminating resistor circuit 529 may correspond to the CDR de-serializer 321, the RX AFE 322, the first MUX 323 including the terminal 335, the second MUX 324 including the terminal 336, and the terminating resistor circuit 329 of FIG. 3, respectively.

The transmitter 530 may include a serializer 531 and/or a TX driver 532. The serializer 531 and the TX driver 532 may correspond to the serializer 331 and the TX driver 332 of FIG. 3, respectively.

The negative data transition mode operates when the serializer signal is a signal corresponding to logical low.

For example, the serializer 531 may receive a data signal from the digital logic 510 and generate a serializer signal corresponding to logical low. The first MUX 523 may be configured to generate a first MUX signal corresponding to logical low by the second external voltage 528 by receiving the serializer signal corresponding to logical low through the terminal 535 connected to the serializer 531. According to embodiments, the logical low serializer signal input to the first MUX 523 may cause the first MUX 523 to switch the output of the first MUX 523 to the second external voltage 528 input to the first MUX 523. According to embodiments, the second external voltage 528 may be a voltage corresponding to a logical low.

In addition, the second MUX 524 may be configured to generate a second MUX signal corresponding to logical high by the first external voltage 527 by receiving an inverted serializer signal corresponding to logical high through the terminal 536 connected to the serializer 531. According to embodiments, the inverted serializer signal (logical high) input to the second MUX 524 may cause the second MUX 524 to switch the output of the second MUX 524 to the first external voltage 527 input to the second MUX 524. According to embodiments, the first external voltage 527 may be a voltage corresponding to a logical high.

The RX AFE 522 may be configured to generate an RX AFE signal based on a first MUX signal corresponding to logical low and a second MUX signal corresponding to logical high. In this case, the first MUX signal, the second MUX signal, and the RX AFE signal may be analog signals.

The CDR de-serializer 521 may be configured to generate a test target signal based on the RX AFE signal corresponding to logical low (this is the signal when the RX AFE 522 operates normally). In detail, the CDR de-serializer 521 may be configured to generate the test target signal by reducing the signal rate of the RX AFE signal. The test target signal may be a digital signal. In detail, the test target signal may be a digital signal corresponding to logical low (this is a signal when the CDR de-serializer 521 operates normally).

The digital logic 510 may determine whether to pass/fail the loopback test for the entire receiver path by comparing the transmitted data signal and the received test target signal. According to embodiments, the digital logic 510 may include a memory (e.g., a buffer) that stores the transmitted data signal for later comparison to the received test target signal.

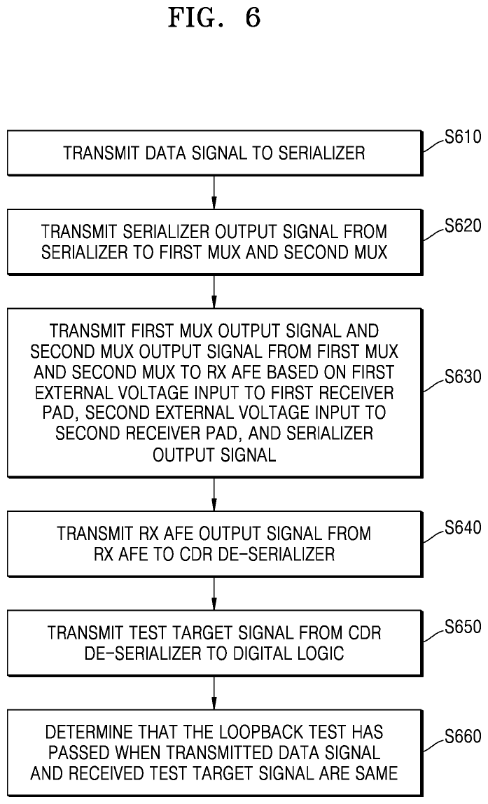

FIG. 6 is a flowchart for explaining a method according to embodiments. Hereinafter, FIG. 6 is described with reference to FIG. 3.

In operation S610, in the method according to embodiments, a data signal may be transmitted to the serializer 331. In detail, the digital logic 310 may generate the data signal and transmit the data signal to the serializer 331.

In operation S620, in the method according to embodiments, a serializer output signal may be transmitted from the serializer 331 to the first MUX 323 and the second MUX 324. In detail, the serializer 331 may transmit the serializer output signal to the first MUX 323 and the second MUX 324, the first MUX 323 may receive the serializer output signal, and the second MUX 324 may receive an inverted serializer output signal.

In operation S630, in the method according to embodiments, the first MUX output signal and the second MUX output signal may be transmitted from the first MUX 323 and the second MUX 324 to the RX AFE 322, based on the first external voltage 327 input to the first receiver pad 325, the second external voltage 328 input to the second receiver pad 326, and the serializer output signal. More specific operations of the first MUX 323 and the second MUX 324 are described below.

In operation S640, in the method according to embodiments, an RX AFE output signal may be transmitted from the RX AFE 322 to the CDR de-serializer 321. In detail, the RX AFE 322 may transmit the RX AFE output signal based on the first MUX output signal and the second MUX output signal. The RX AFE 322 may generate and transmit an RX AFE signal by improving the signal characteristics of the signals input to the RX AFE 322. For example, the RX AFE 322 may generate the RX AFE output signal by compensating for signal loss or signal distortion of the first MUX output signal and the second MUX output signal.

In operation S650, in the method according to embodiments, a test target signal may be transmitted from the CDR de-serializer 321 to the digital logic 310. In detail, the CDR de-serializer 321 may generate the test target signal based on the RX AFE output signal. For example, the CDR de-serializer 321 may generate the test target signal by reducing the signal rate of the RX AFE output signal.

In addition, the CDR de-serializer 321 may generate the test target signal by converting the RX AFE output signal, which is an analog signal, into a digital signal.

In operation S660, in the method according to embodiments, when the transmitted data signal and the received test target signal are the same (or similar), it may be determined that the loopback test has passed. In detail, the digital logic 310 determines that the loopback test has passed when the transmitted data signal and the received test target signal are the same (or similar) and may determine that the loopback test has failed when the transmitted data signal and the received test target signal are different from each other.

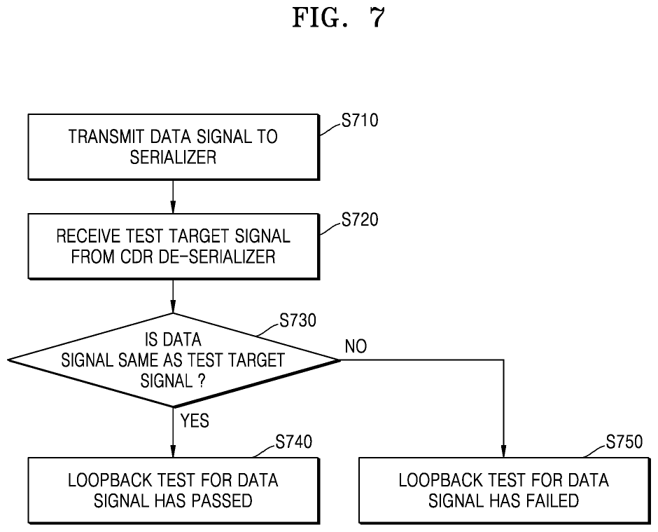

FIG. 7 is a flowchart for explaining the operation of a digital logic according to embodiments.

In operation S710, in a method according to embodiments, data may be transmitted to a serializer.

In operation S720, in the method according to embodiments, a test target signal may be received from a CDR de-serializer.

In operation S730, in the method according to embodiments, it may be determined whether the data signal and the test target signal are the same (or similar). According to embodiments, the digital logic 310 may determine whether the data signal matches the test target signal.

In operation S740, in the method according to embodiments, when the data signal and the test target signal are the same (or similar), it may be determined that the loopback test for the data signal has passed.

In operation S750, in the method according to embodiments, when the data signal is different from the test target signal, it may be determined that the loopback test for the data signal has failed. According to embodiments, the digital logic 310 may generate a communication signal indicating a result of the loopback test (e.g., pass or fail) and output the communication signal (e.g., to a user interface, a communication interface, etc.).

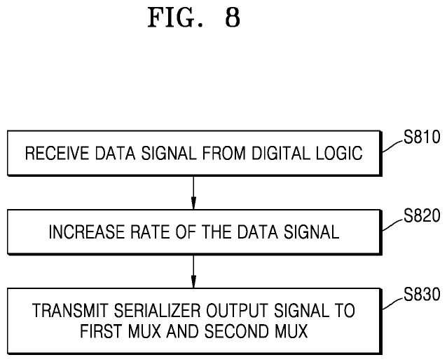

FIG. 8 is a flowchart for explaining the operation of a serializer according to embodiments.

In operation S810, in a method according to embodiments, a data signal may be received from a digital logic.

In operation S820, in the method according to embodiments, the rate of the data signal may be increased.

In operation S830, in the method according to embodiments, a serializer output signal may be transmitted to the first MUX and the second MUX.

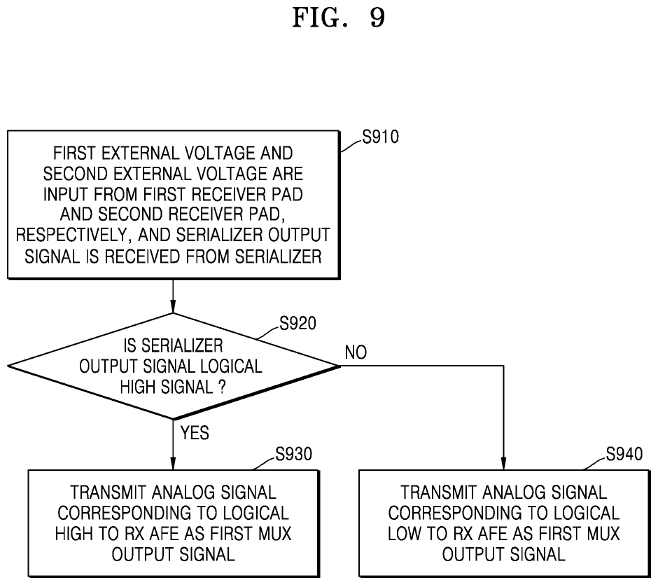

FIG. 9 is a flowchart for explaining an operation of a first MUX according to embodiments.

In operation S910, in a method according to embodiments, a first external voltage and a second external voltage may be input from a first receiver pad and a second receiver pad, respectively, and a serializer output signal may be received from a serializer.

In operation S920, in the method according to embodiments, it may be determined whether the serializer output signal is a signal corresponding to logical high.

In operation S930, in the method according to embodiments, when the serializer output signal corresponds to a logical high signal, an analog signal corresponding to logical high may be transmitted to an RX AFE as the first MUX output signal.

In operation S940, in the method according to embodiments, when the serializer output signal corresponds to a logical low signal, an analog signal corresponding to logical low may be transmitted to the RX AFE as the first MUX output signal.

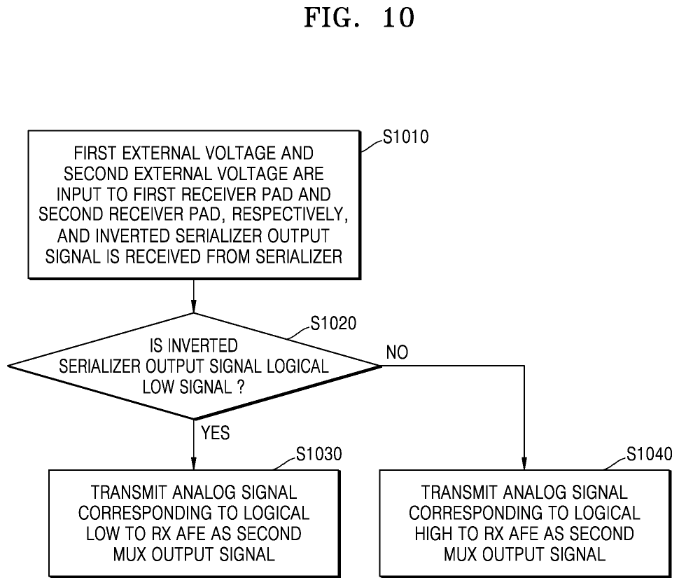

FIG. 10 is a flowchart for explaining the operation of a second MUX according to embodiments.

In operation S1010, in a method according to embodiments, a first external voltage and a second external voltage may be input from the first receiver pad and the second receiver pad, respectively, and an inverted serializer output signal may be received from the serializer.

In operation S1020, in the method according to embodiments, it may be determined whether the inverted serializer output signal is a signal corresponding to logical low.

In operation S1030, in the method according to embodiments, when the inverted serializer output signal corresponds to a logical low signal, an analog signal corresponding to logical low may be transmitted to the RX AFE as the second MUX output signal.

In operation S1040, in the method according to embodiments, when the inverted serializer output signal corresponds to a logical high signal, an analog signal corresponding to logical high may be transmitted to the RX AFE as the second MUX output signal.

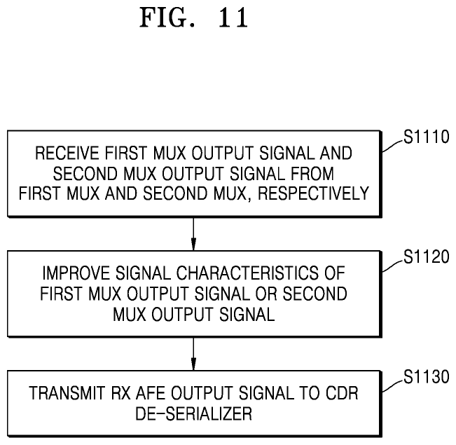

FIG. 11 is a flowchart for explaining the operation of an RX AFE according to embodiments.

In operation S1110, in a method according to embodiments, a first MUX output signal and a second MUX output signal may be received from a first MUX and a second MUX, respectively.

In operation S1120, the method according to embodiments may improve signal characteristics of the first MUX output signal or the second MUX output signal. In detail, in the method, signal loss or signal distortion of the first MUX output signal or the second MUX output signal may be compensated for.

In operation S1130, in the method according to embodiments, the RX AFE output signal may be transmitted to a CDR de-serializer.

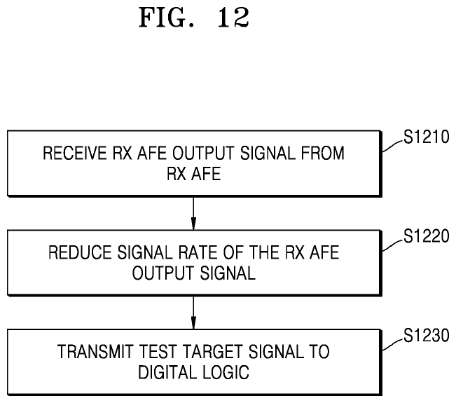

FIG. 12 is a flowchart for explaining the operation of a CDR de-serializer according to embodiments.

In operation S1210, in a method according to embodiments, an RX AFE output signal may be received from the RX AFE.

In operation S1220, in the method according to embodiments, the signal rate of the RX AFE output signal may be reduced.

In operation S1230, in the method according to embodiments, a test target signal may be transmitted to the digital logic.

Conventional devices and methods for performing transceiver testing (e.g., built in self tests (BISTs)) perform internal loopback tests, external loopback tests and full path internal loopback tests. The internal loopback tests involve connecting a transmitter of the transceiver with a receiver of the transceiver to form a loop. While the internal loopback tests reduce package costs, test coverage is low because the loop does not extend through an external pad. For example, the internal loopback tests are unable to test transmitter drivers and/or receiver analog front ends that are directly connected to external pads.

The external loopback tests involve connecting the transmitter and the receiver from external pads (external with respect to a chip containing the transmitter and receiver) to form a loop. The external loopback tests provide higher coverage, but involve probing issues and/or limitations in operating frequencies. For example, the external loopback tests are insufficiently smooth at higher frequencies.

The conventional full path internal loopback tests involve adding a pseudo transmitter test circuit, thereby providing improved test coverage with respect to the internal loopback tests by enabling testing of the receiver analog front ends. However, the pseudo transmitter test circuit of the conventional full path internal loopback tests is unrelated to the normal operation of the transceiver, and thus, result in an excessive increase in area (e.g., physical area) of the transceiver (e.g., of a wafer containing the transceiver).

However, according to embodiments, improved devices and methods are provided for performing transceiver testing (e.g., built in self tests (BISTs)). For example, the improved devices and methods may include a circuit (e.g., the first MUX 323, the second MUX 324 and/or the terminating resistor circuit 329) that operates a transmitter of the transceiver and is included in a receiver of the transceiver. This circuit occupies a decreased area (e.g., physical area) of the transceiver (e.g., of a wafer containing the transceiver) as compared to the pseudo transmitter test circuit of the conventional full path internal loopback tests while enabling testing of the receiver analog front ends. Accordingly, the improved devices and methods overcome the deficiencies of both the internal loopback tests and conventional full path internal loopback tests of the conventional devices and methods. Also, the improved devices and methods provide for smoother testing even at higher frequencies, thereby overcoming the deficiencies of the external loopback tests of the conventional devices and methods.

According to embodiments, operations described herein as being performed by the transceiver 100, the digital logic 110, the receiver 120, the transmitter 130, the transceiver 200, the digital logic 210, the receiver 220, the transmitter 230, the CDR de-serializer 221, the RX AFE 222, the first MUX 223, the second MUX 224, the serializer 231, the TX driver 232, the transceiver 300, the digital logic 310, the receiver 320, the transmitter 330, the terminating resistor circuit 329, the CDR de-serializer 321, the RX AFE 322, the first MUX 323, the second MUX 324, the serializer 331, the TX driver 332, the transceiver 400, the digital logic 410, the receiver 420, the transmitter 430, the CDR de-serializer 421, the RX AFE 422, the first MUX 423, the second MUX 424, the terminating resistor circuit 429, the serializer 431, the TX driver 432, the transceiver 500, the digital logic 510, the receiver 520, the transmitter 530, the CDR de-serializer 521, the RX AFE 522, the first MUX 523, the second MUX 524, the terminating resistor circuit 529, the serializer 531 and/or the TX driver 532 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., a memory of the digital logic 110, the digital logic 210, the digital logic 310, the digital logic 410 and/or the digital logic 510). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

While the inventive concepts have been particularly shown and described with reference to embodiments thereof, it will be understood that various changes in form and details may be made therein without departing from the spirit and scope of the following claims.

What is claimed is:

1. A transceiver comprising:
a transmitter;
a first receiver pad configured to receive a first external voltage;
a second receiver pad configured to receive a second external voltage;
a receiver configured to generate a test target signal based on the first external voltage and the second external voltage; and
a digital logic configured to perform a loopback test on a reception path of a data signal by transmitting the data signal and receiving the test target signal.

2. The transceiver of claim 1, wherein the transmitter comprises:
a serializer configured to generate a serializer signal by increasing a signal rate of the data signal; and
a transmitter (TX) driver configured to receive the serializer signal.

3. The transceiver of claim 2, wherein the receiver comprises:
a first multiplexer (MUX) configured to
receive the first external voltage and the second external voltage, and
generate a first MUX signal based on the serializer signal;
a second MUX configured to
receive the first external voltage and the second external voltage, and
generate a second MUX signal based on an inverted serializer signal, the inverted serializer signal being inverted with respect to the serializer signal;
an receiver analog front end (RX AFE) configured to generate an RX AFE signal based on the first MUX signal and the second MUX signal; and
a clock data recovery (CDR) de-serializer configured to generate the test target signal by reducing a signal rate of the RX AFE signal.

4. The transceiver of claim 3, wherein the RX AFE is configured to generate the RX AFE signal by compensating for signal distortion or signal loss of the first MUX signal and the second MUX signal.

5. The transceiver of claim 3, wherein the CDR de-serializer is configured to convert analog signals to digital signals.

6. The transceiver of claim 3, wherein
the first MUX is configured to
generate an analog signal corresponding to logical high when the serializer signal is a logical high digital signal, and
generate an analog signal corresponding to logical low when the serializer signal is a logical low digital signal; and
the second MUX is configured to
generate an analog signal corresponding to logical low when the serializer signal is a logical high digital signal, and
generate an analog signal corresponding to logical high when the serializer signal is a logical low digital signal.

7. The transceiver of claim 1, wherein the digital logic is configured to determine that the loopback test has passed when the data signal and the test target signal are the same.

8. The transceiver of claim 1, wherein
the first external voltage has a voltage corresponding to logical high; and
the second external voltage has a voltage corresponding to logical low.

9. The transceiver of claim 1, wherein the first external voltage and the second external voltage are variable.

10. The transceiver of claim 1, wherein
the receiver comprises an RX AFE configured to determine a threshold; and
a voltage difference between the first external voltage and the second external voltage is greater than or equal to the threshold.

11. The transceiver of claim 2, further comprising:
at least one terminating resistor connected to the first receiver pad or the second receiver pad, the at least one terminating resistor being configured to change a terminating resistance value.

12. The transceiver of claim 1, further comprising:
at least one terminating resistor connected to the first receiver pad or the second receiver pad, the at least one terminating resistor being configured to change a terminating resistance value.

13. The transceiver of claim 12, further comprising:
at least one switch connected to the at least one terminating resistor, the terminating resistance value changing based on whether the at least one switch is on or off.

14. The transceiver of claim 1, wherein the data signal is a random data signal.

15. A transceiver comprising:
a first receiver pad configured to receive a first external voltage;
a second receiver pad configured to receive a second external voltage;
a first multiplexer (MUX) connected to the first receiver pad and the second receiver pad;
a second MUX connected to the first receiver pad and the second receiver pad;
a receiver analog front end (RX AFE), the first MUX and the second MUX each being connected to an input terminal of the RX AFE;
a clock data recovery (CDR) de-serializer connected to the RX AFE;
a digital logic connected to the CDR de-serializer, the digital logic being configured to perform a loopback test on a reception path of a data signal by generating the data signal; and
a serializer connected to the first MUX, the second MUX, and the digital logic.

16. The transceiver of claim 15, wherein the digital logic is configured to perform a loopback test on the reception path of the data signal by transmitting the data signal to the serializer and receiving a test target signal from the CDR de-serializer.

17. The transceiver of claim 16, wherein the digital logic is configured to determine that the loopback test has passed when the data signal and the test target signal are the same.

18. The transceiver of claim 15, wherein
the first external voltage has a voltage corresponding to logical high; and
the second external voltage has a voltage corresponding to logical low.

19. The transceiver of claim 15, further comprising:
at least one resistor connected between the first receiver pad and the second receiver pad; and
a switch connected to the at least one resistor.

20. A loopback test method for a transceiver, the method comprising:
transmitting a data signal to a serializer;
transmitting a serializer output signal from the serializer to a first multiplexer (MUX) and a second MUX;
transmitting a first MUX output signal and a second MUX output signal to a receiver analog front end (RX AFE) based on a first external voltage input to a first receiver pad, a second external voltage input to a second receiver pad, and the serializer output signal, the transmitting including transmitting the first MUX output signal from the first MUX and transmitting the second MUX output signal from the second MUX;
transmitting an RX AFE output signal from the RX AFE to a clock data recovery (CDR) de-serializer;
transmitting a test target signal from the CDR de-serializer to a digital logic; and
determining that a loopback test is passed when the data signal and the test target signal are the same.
